(19) United States
(12) Patent Application Publication
(10) Pub. No.: US 2026/0003530 A1
(43) Pub. Date: Jan. 1, 2026

(54) DUPLICATIVE DATA WRITE PREVENTION

(71) Applicant: MELLANOX TECHNOLOGIES, LTD., Yokneam (IL)

(72) Inventors: Lokesh ARORA, Faridabad (IN); Shai MALIN, Tel Aviv (IL); Dana BENBASAT, Givatayim (IL); Doron PODRABINOK, Netanya (IL)

(73) Assignee: MELLANOX TECHNOLOGIES, LTD., Yokneam (IL)

(21) Appl. No.: 19/208,832

(22) Filed: May 15, 2025

Related U.S. Application Data
(63) Continuation-in-part of application No. 18/758,558, filed on Jun. 28, 2024.

(51) Int. Cl. G06F 3/06

(52) U.S. Cl. CPC G06F 3/0641; G06F 3/0608; G06F 3/0659; G06F 3/067

(57) ABSTRACT

Methods, systems, devices, and computer program products for preventing duplicative data writes in networking applications are provided. An example data processing unit (DPU) including a data deduplication engine coupled to a non-transitory storage device including at least a processor receives, from an initiating device, a request for a data write operation that includes data identifiers indicative of data entries associated with the data write operation. The data deduplication engine determines a destination write location for the data write operation that is associated with one or more deduplication parameters. The data deduplication engine then accesses one or more data identifiers indicative of data entries stored by the destination write location and precludes writing of duplicate data entries to the destination write location based on a comparison between the data identifiers of the data write operation and the data identifiers indicative of data entries stored by the destination write location.

### CROSS-REFERENCE TO RELATED APPLICATIONS

The present application is a continuation-in-part application of U.S. patent application Ser. No. 18/758,558, filed Jun. 28, 2024, the entire contents of which application are incorporated by reference in their entirety.

### TECHNOLOGICAL FIELD

Embodiments of the present disclosure relate generally to networking and computing systems, and, more particularly, to the prevention of duplicative data writes in datacenter and other networking applications.

### BACKGROUND

Datacenters, high performance computing clusters, and/or other networking applications are often implemented via distributed network components or devices (e.g., hosts, servers, racks, switches, nodes, etc.). In processing the data traffic that is transmitted over these networks, data may be transmitted from a host device to a backend storage device through a data transmission path. The backend storage device, however, may store duplicative copies of the data received via the data path.

### BRIEF SUMMARY

Through applied effort, ingenuity, and innovation, many of the problems associated with conventional networking and computing systems have been solved by developing solutions that are included in embodiments of the present disclosure, many examples of which are described in detail herein. Embodiments of the present disclosure therefore provide for methods, systems, devices, and computer program products for preventing duplicative data writes in networking applications. An example data processing unit (DPU) for preventing duplicative data writes may include a non-transitory storage device and a data deduplication engine coupled to the non-transitory storage device including at least a processor. The data deduplication engine may be configured to receive, from an initiating device, a request for a data write operation. The data write operation may be associated with a destination write location and include one or more data identifiers indicative of data entries for writing to the destination write location. The data deduplication engine may be configured to access one or more data identifiers indicative of data entries stored by the destination write location and preclude writing of duplicate data entries to the destination write location based on a comparison between the one or more data identifiers of the data write operation and the one or more data identifiers indicative of data entries stored by the destination write location.

In some embodiments, the one or more data identifiers indicative of data entries stored by the destination write location may be stored locally by the DPU.

In some embodiments, in accessing the one or more data identifiers indicative of data entries stored by the destination write location, the data deduplication engine may be configured to access a data repository storing the one or more data identifiers indicative of data entries stored by the destination write location.

In some further embodiments, the data repository may be distinct from the destination write location.

In some embodiments, the data deduplication engine may be configured to access the one or more data identifiers indicative of data entries stored by the destination write location in the absence of a transmission to the destination write location.

In some embodiments, the data deduplication engine may be further configured to compare the one or more data identifiers of the data write operation and the one or more data identifiers indicative of data entries stored by the destination write location and determine one or more data identifiers of the data write operation that are absent from the one or more data identifiers indicative of data entries stored by the destination write location.

In some further embodiments, the data deduplication engine may be further configured to transmit the one or more absent data identifiers to the initiating device, receive data entries associated with the one or more absent data identifiers, and cause writing of the received data entries of the one or more absent data identifiers to the destination write location.

In some still further embodiments, a number of the one or more data identifiers of the data write operation may be greater than a number of the absent data identifiers transmitted to the initiating device.

Embodiments of the present disclosure may also provide for methods, systems, devices, and computer program products for memory system identification and duplicative data write prevention in networking applications. An example data processing unit (DPU) for preventing duplicative data writes may include a non-transitory storage device and a data deduplication engine coupled to the non-transitory storage device including at least a processor. The data deduplication engine may be configured to receive, from an initiating device, a request for a data write operation. The data write operation may include one or more data identifiers indicative of data entries associated with the data write operation. The data deduplication engine may be configured to determine a destination write location for the data write operation that is associated with one or more deduplication parameters. The data deduplication engine may be configured to access one or more data identifiers indicative of data entries stored by the destination write location and preclude writing of duplicate data entries to the destination write location based on a comparison between the one or more data identifiers of the data write operation and the one or more data identifiers indicative of data entries stored by the destination write location.

In some embodiments, the one or more deduplication parameters may be indicative of a memory system type of the destination write location.

In some further embodiments, the data deduplication engine may be configured to determine, based on the one or more deduplication parameters, that the destination write location comprises a file system memory type.

In some embodiments, the request for the data write operation may include the one or more deduplication parameters associated with the destination write location.

In some embodiments, the data deduplication engine may be further configured to preclude writing of duplicate data entries to the destination write location based at least in part on the one or more deduplication parameters associated with the destination write location.

In some embodiments, the one or more data identifiers indicative of data entries stored by the destination write location may be stored locally by the DPU.

In some embodiments, in accessing the one or more data identifiers indicative of data entries stored by the destination write location, the data deduplication engine may be configured to access a data repository storing the one or more data identifiers indicative of data entries stored by the destination write location.

In some further embodiments, the data repository may be distinct from the destination write location.

In some embodiments, the data deduplication engine may be configured to access the one or more data identifiers indicative of data entries stored by the destination write location in the absence of a transmission to the destination write location.

In some embodiments, the data deduplication engine may be further configured to compare the one or more data identifiers of the data write operation and the one or more data identifiers indicative of data entries stored by the destination write location and determine one or more data identifiers of the data write operation that are absent from the one or more data identifiers indicative of data entries stored by the destination write location.

In some further embodiments, the data deduplication engine may be further configured to transmit the one or more absent data identifiers to the initiating device, receive data entries associated with the one or more absent data identifiers, and cause writing of the received data entries of the one or more absent data identifiers to the destination write location.

In some still further embodiments, a number of the one or more data identifiers of the data write operation may be greater than a number of the absent data identifiers transmitted to the initiating device.

In some still further embodiments, the data deduplication engine may be configured to receive the data entries associated with the one or more absent data identifiers via Remote Direct Memory Access (RDMA).

In any embodiment, the one or more data identifiers may include Secure Hash Algorithms (SHAs).

In any embodiment, the data deduplication engine may be configured to preclude writing of duplicate data entries to the destination write location in the absence of accessing data stored by the destination write location.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example data transmission path in accordance with an example embodiment of the present disclosure;

FIG. 2 illustrates an example data deduplication device (e.g., an example DPU-based device) in accordance with an example embodiment of the present disclosure;

FIG. 3 illustrates a block diagram of example circuitry (e.g., DPU circuitry) that may be specifically configured in accordance with an example embodiment of the present disclosure;

FIG. 4 illustrates a flowchart of an example method for preventing duplicative data writes in accordance with some embodiments of the present disclosure;

FIG. 5 illustrates another flowchart of an example method for preventing duplicative data writes in accordance with some embodiments of the present disclosure;

FIG. 6 illustrates a flowchart of an example method for memory system determination and duplicative data write prevention in accordance with some embodiments of the present disclosure; and

FIG. 7 illustrates another flowchart of an example method for preventing duplicative data writes in accordance with some embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As described above, datacenters, high performance computing clusters, and/or other networking applications are often implemented via distributed network components or devices (e.g., hosts, servers, racks, switches, nodes, etc.). In processing the data traffic of these example networks, effectuating storage input/output acceleration, and/or supporting other storage applications, data may be required to be transmitted from a host to a backend storage through a data transmission path that includes a data processing unit (DPU). In operation, the DPU retrieves data from a host memory and transfers this data to backend storage but may, in some instances, encounter duplicate data (e.g., data that is already stored in the backend storage). In traditional systems, offline deduplication may be used in which duplicate data is initially stored by the backend storage and then is subsequently eliminated, and/or inline deduplication may be used in which the DPU retrieves data from the host memory for identifying duplicate data. In these conventional approaches, however, the DPU is required to read the duplicate data entries from the backend storage. The reading of duplicative data from the backend storage (e.g., an example destination write location) in conventional offline and inline deduplication techniques, however, increases the network bandwidth utilization associated with these systems.

In order to solve these issues and others, the embodiments of the present disclosure provide DPU devices and methods with a deduplication engine that removes the requirement for accessing the backend storage and prevents duplicate data from being transmitted over the network. For example, the deduplication engine of the DPUs (e.g., an example data deduplication device) described herein may receive a data write operation (e.g., a scatter/gather list (SGL) that points to the secure hashing algorithms (SHAs) of data to be written), and the deduplication engine may process the SHAs (e.g., data identifiers) to identify SHAs that are not present within the deduplication engine. The type of memory system (e.g., block, object, file, etc.) may further impact the type of deduplication operations that occur. The deduplication engine may then transmit the indices of the SHAs (e.g., data identifiers) that are not present within the engine, and the host transmits the data write operation (e.g., the SGL) with only the unique data. The DPU may then update the data deduplication engine and write only the unique data to the backend storage. Said differently, the embodiments of the present disclosure may preclude the writing of duplicate data entries to the backend storage (e.g., destination write location) in the absence of accessing data stored by the backend storage. In doing so, the methods, systems, and devices described herein may provide improved storage and backup capacity, promote improved data recovery, support improved network optimization, and reduce associated networking costs.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Data Deduplication Devices and Systems

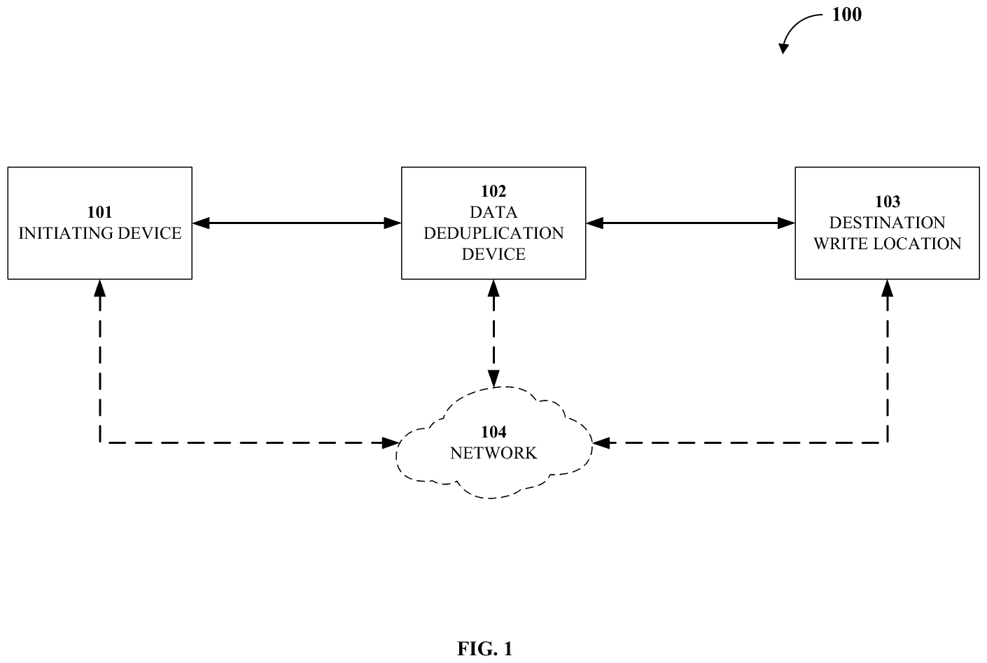

FIG. 1 illustrates an example data transmission path in an example network (e.g., data transmission path and/or network 100). It will be appreciated that the data transmission path 100 is provided as an example of an embodiment(s) and should not be construed to narrow the scope or spirit of the disclosure. The depicted data transmission path 100 of FIG. 1 may include an initiating device 101 communicably coupled with a destination write location 103 via a data deduplication device 102 (e.g., an example DPU 200). For example, the initiating device 101 may be a host device, and the destination write location 103 may be an example backend storage device. The initiating device 101 may transmit data (e.g., data entries or the like), via the data transmission path 100, that is to be written to the destination write location 103, and this data may be received by the data deduplication device 102 (e.g., an example DPU). In some embodiments, the initiating device 101, the data deduplication device 200, and/or the destination write location 103 may be communicably coupled via direct physical connections. Additionally or alternatively, in some embodiments, as shown in FIG. 1, the initiating device 101, the data deduplication device 200, and/or the destination write location 103 may be communicably coupled via a network 104.

Although described hereinafter with reference to an example host device as the initiating device 101, the present disclosure contemplates that the operations described hereafter with reference to the initiating device 101 may be performed by any computing device, system orchestrator, central processing unit (CPU), graphics processing unit (GPU), and/or the like. Furthermore, although illustrated as a single device (e.g., initiating device 101), the present disclosure contemplates that any number of distributed components may collectively be used to form the initiating device 101 and/or to perform the operations associated with the initiating device 101. Furthermore, although illustrated and described herein with reference to a single initiating device 101 (e.g., an example host device), the present disclosure contemplates that an example network that includes the data transmission path 100 may include any number of computing devices that may operate as the initiating device 101. Furthermore, the present disclosure contemplates that, in some instances, a plurality of initiating devices 101 may be associated with the data deduplication device 102 and/or the destination write location 103. In other words, the initiating device 101 may refer to any device that generates a request for a data write operation as described hereinafter.

Although described hereinafter with reference to an example backend storage device as the destination write location 103, the present disclosure contemplates that the operations described hereafter with reference to the destination write location 103 may be performed by any computing device, system orchestrator, central processing unit (CPU), graphics processing unit (GPU), and/or the like. Furthermore, although illustrated as a single device (e.g., destination write location 103), the present disclosure contemplates that any number of distributed components may collectively be used to form the destination write location 103 and/or to perform the operations associated with the destination write location 103. Furthermore, although illustrated and described herein with reference to a single destination write location 103 (e.g., an example backend storage device), the present disclosure contemplates that an example network that includes the data transmission path 100 may include any number of computing devices that may operate as the destination write location 103. Furthermore, the present disclosure contemplates that, in some instances, a plurality of destination write locations 103 may be associated with the data deduplication device 102 and/or the initiating device 101. In other words, the destination write location 103 may refer to any device that is capable of storing data and/or at which data may be written as described hereinafter. Furthermore, the destination write location 103 may, in some embodiments, be associated with a memory system type (e.g., object, block, file, or the like).

An object memory system (e.g., object storage) may refer to a memory or storage technique or system in which data is often stored in an unstructured format (e.g., objects). These objects may, for example, be distributed across a plurality of devices in the system (e.g., a plurality of devices collectively operating as the destination write location 103). The objects of an object memory system may further be stored in a flat structure or configuration (e.g., a bucket or the like) as opposed to a tiered or hierarchical configuration. An object memory system may store data (e.g., objects) in the native format of the data and leverage metadata of the particular data objects (e.g., the particular data writes) as unique identifiers for the data. In doing so, object memory systems may provide increased scalability by allowing any object in the flat structure (e.g., the bucket) to be retrieved, analyzed, etc. regardless of the function, attributes, characteristics, etc. of the object (e.g., the data written to the object memory storage).

A block memory system may refer to a memory or storage technique or system in which data is divided and stored in blocks of equal sizes with blocks operating as individual storage units within the block memory system. The size of the blocks may vary based on the application of the storage system (e.g., the destination write location 103). As described hereinafter, the blocks of a block memory system may leverage Logical Block Addresses (e.g., addressing schemes for identifying each data block) and a data lookup table that stores the unique block number or logical block address for each block in the memory system. In doing so, block memory systems may provide efficient and reliable data access in which the systems described herein may directly access individual blocks of the memory system without retrieving or modification of the complete dataset to which the particular block belongs.

A file memory system may refer to a memory or storage technique or system in which data is stored in a hierarchical or tiered configuration, such as in various memory levels, trees, folders, etc. The present disclosure contemplates that the particular configuration of the file storage system (e.g., the example destination write location 103) may be configured based on the intended application of the destination write location 103. An example file memory system may also use metadata, such as file size, file name, edit time, save time, access time, user permissions, and/or the like, that is associated with each file in the system. A file memory system may further allow for the logical organization, grouping, etc. of files as well as the simultaneous access of files by multiple users and/or devices. As described herein, one or more deduplication parameters of the destination write location 103 may be used to determine the memory system type (e.g., object, block, file, etc.) of the destination write location 103.

To facilitate or otherwise enable this connectivity, the communication network 104 may be any means including hardware, software, devices, or circuitry that is configured to support the transmission of traffic (e.g., data, signals, etc.) between devices forming the network of data transmission path. For example, the communication network 104 may be formed of components supporting wired transmission protocols, such as, digital subscriber line (DSL), InfiniBand®, Ethernet, fiber distributed data interface (FDDI), or any other wired transmission protocol obvious to a person of ordinary skill in the art. The communication network 104 may also be comprised of components supporting wireless transmission protocols, such as Bluetooth, IEEE 802.11 (Wi-Fi), or other wireless protocols obvious to a person of ordinary skill in the art. In addition, the communication network 104 may be formed of components supporting a standard communication bus, such as, a Peripheral Component Interconnect (PCI), PCI Express (PCIe or PCI-e), PCI eXtended (PCI-X), Accelerated Graphics Port (AGP), or other similar high-speed communication connection. Further, the communication network 104 may be comprised of any combination of the above mentioned protocols.

In some embodiments, as described hereinafter, the data write operation that is received by the data deduplication device 102 (e.g., an example DPU) from the initiating device 101 may be based on a nonvolatile memory express NVMe based data transmission protocol. Additionally or alternatively, in some embodiments, the writing of data to the write destination location 103 may occur via one or more remote direct memory access (RDMA) operations. As such, the present disclosure contemplates that the network 104 may include any number of devices, components, circuitries implementations, etc. so as to enable NVMe and RDMA based operations. Although described herein with reference to NVMe and RDMA data transmission protocols, the present disclosure contemplates that the devices, systems, and methods of the present disclosure may be applicable to any data transmission protocol (e.g., virtio-blk or the like). The present disclosure further contemplates that the data transmission protocol may vary based on the type of memory system for the destination write location 103. As described hereinafter, one or more deduplication parameters associated with the destination write location 103 may be indicative of a memory system type (e.g., block, object, file, etc.) of the destination write location 103 and may further determine the data transmission protocol employed by the system.

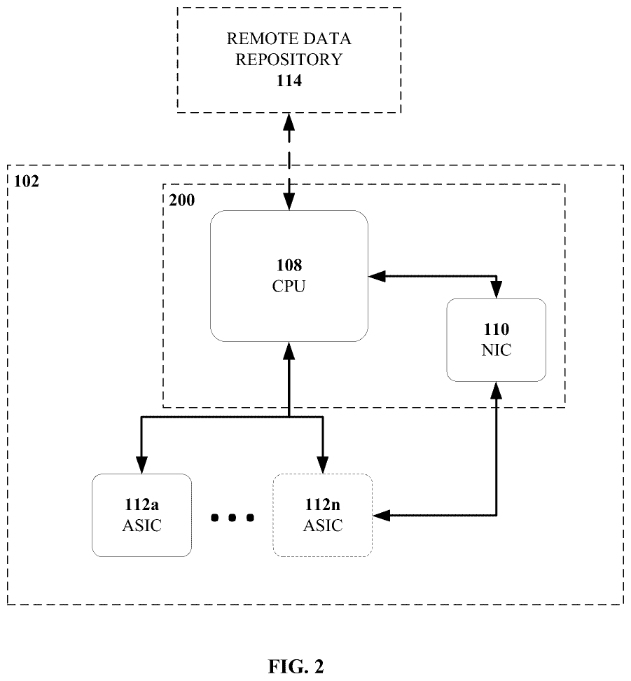

With reference to FIG. 2, an example data deduplication device 102 is illustrated. As shown, the data deduplication device 102 may include one or more application-specific integrated circuits (ASICs) 112a-n that are communicably coupled with a data processing unit (DPU) 200. The one or more ASICs 112a-n may be configured for performing one or more networking operations and may be specific to the particular functionality associated with the data deduplication device 102. By way of nonlimiting example, the one or more ASICs 112a-112n may be configured to operate as network ports in which traffic (e.g., data, signals, etc.) are directed to various components, devices, etc. communicably coupled with the ASICs 112a-n. The present disclosure contemplates that the data deduplication device 102 may include any number of ASICs 112a-n (e.g., a plurality of ASICs 112a-n) based upon the intended application of the data deduplication device 102. Additionally, the present disclosure contemplates that the operations performed by the one or more ASICs 112a-n may similarly vary based upon the intended application of the data deduplication device 102.

The data deduplication device 102 may further include a DPU 200 that is operably coupled with the one or more ASICs 112a-112n. As would be evident to one of ordinary skill in the art in light of the present disclosure, a DPU 200 may refer to a programmable computer processor that tightly integrates a general-purpose CPU (e.g., CPU 108) with network interface hardware (e.g., NIC 110). Although described herein as a Data Processing Unit (DPU) 200, the present disclosure contemplates that the DPU 200 may similarly be referred to as an infrastructure processing unit (IPU), SmartNIC, and/or the like.

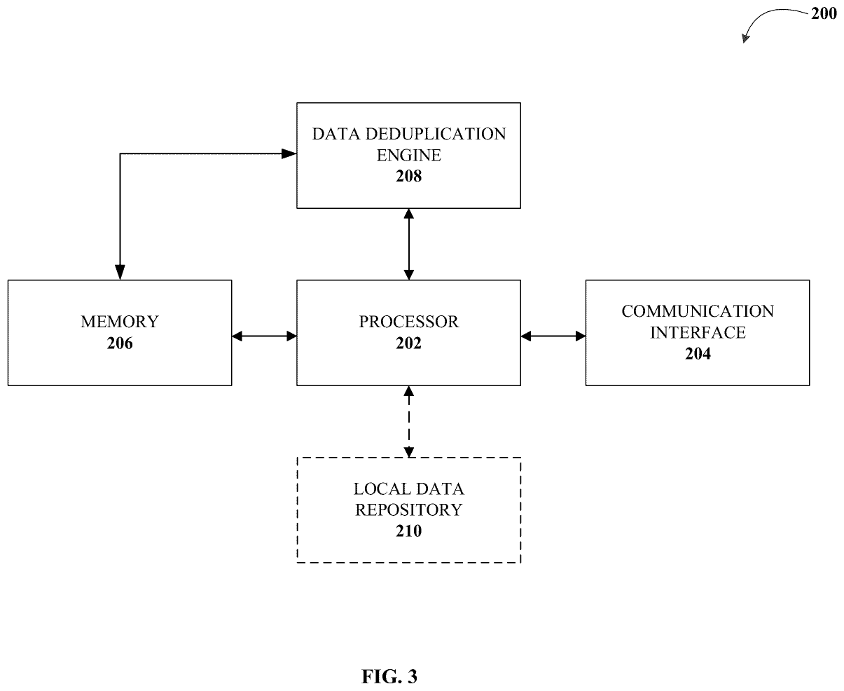

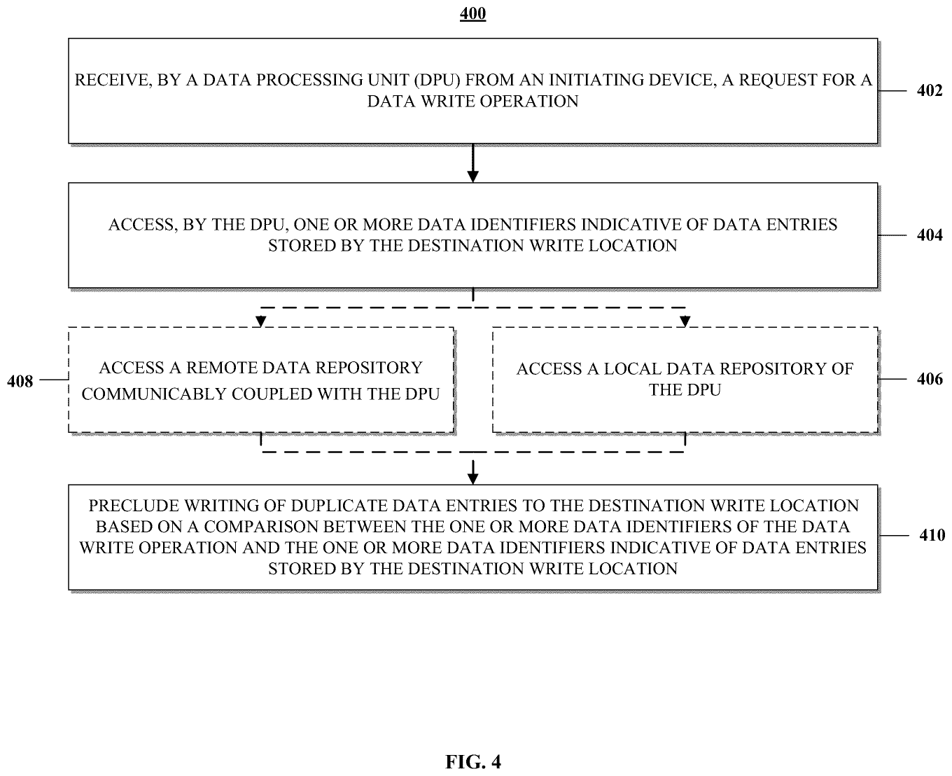

As shown, the DPU 200 may include a high-performance, software-programmable central processing unit (CPU) 108 that is communicably coupled with a network interface controller (NIC) 110. As described hereinafter with reference to the circuitry components of FIG. 3 and the operations of FIGS. 4-7, the CPU 108 and the NIC 110 may be configured to performed data deduplication operations in-line and responsive to a data write operation in the absence of accessing data stored by the destination write location 103. Said differently, the DPU 200 may be configured as described herein to preclude the writing of duplicate data entries to the destination write location 103 without accessing the destination write location 103 to determine the data entries that are currently stored by the destination write location 103. The DPU 200 may further, in some embodiments, be configured to determine the destination write location 103 for the data write operation and/or determine the memory system type of the destination write location 103, such as based on one or more deduplication parameters of the destination write location 103.

The data deduplication device 102 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware. In some embodiments, data deduplication device 102 may be embodied on the same physical device as the initiating device 101. In some embodiments, the data deduplication device 102 may be remote to the initiating device 101.

In some embodiments, the DPU 200 of the example data deduplication device 102 may be communicably coupled with a remote data repository 114. As described hereinafter, in some embodiments, one or more data identifiers indicative of data entries stored by the destination write location may be stored remotely from the DPU 200, such as in an example remote data repository 114. In such an embodiment, remote data repository 114 may be non-transitory and may include, for example, one or more volatile and/or non-volatile memories. In other words, for example, the remote data repository 114 may be an electronic storage device (e.g., a computer readable storage medium) comprising gates configured to store data (e.g., bits) that may be retrievable by a machine (e.g., DPU 200 or the like). In such an embodiment, the DPU 200 may be configured to access the remote data repository 114, such as to retrieve one or more data identifiers indicative of data entries stored by the destination write location 103.

### Example DPU Circuitry

With reference to FIG. 3, example circuitry components of the DPU 200 (e.g., the CPU 108 and/or the NIC 110) are illustrated that may, alone or in combination with any of the components described herein, be configured to perform the operations described herein with reference to FIGS. 4-7. As shown, the DPU 200 may include, be associated with or be in communication with processor 202, a memory 206, a communication interface 204, and a data deduplication engine 208. In some embodiments, the DPU may further include or otherwise be associated with a local data repository 210. The processor 202 may be in communication with the memory 206 via a bus for passing information among components of the DPU 200. The memory 206 may be non-transitory and may include, for example, one or more volatile and/or non-volatile memories. In other words, for example, the memory 206 may be an electronic storage device (e.g., a computer readable storage medium) comprising gates configured to store data (e.g., bits) that may be retrievable by a machine (e.g., a computing device like the processing circuitry). The memory 206 may be configured to store information, data, content, applications, instructions, or the like for enabling the device to carry out various functions in accordance with an example embodiment of the present disclosure. For example, the memory 206 could be configured to buffer input data for processing by the processor 202. Additionally or alternatively, the memory 206 could be configured to store instructions for execution by the processor 202.

The DPU 200 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 202 may be configured to execute instructions stored in the memory 206 or otherwise accessible to the processor 202. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 202 is embodied as an executor of instructions, the instructions may specifically configure the processor to perform the algorithms and/or operations described herein when the instructions are executed. However, in some cases, the processor 202 may be a processor of a specific device configured to employ an embodiment of the present disclosure by further configuration of the processing circuitry by instructions for performing the algorithms and/or operations described herein. The processor 202 may include, among other things, a clock, an arithmetic logic unit (ALU) and logic gates configured to support operation of the processing circuitry.

The communication interface 204 may be any means such as a device or circuitry embodied in either hardware or a combination of hardware and software that is configured to receive and/or transmit data, including media content in the form of video or image files, one or more audio tracks or the like. In this regard, the communication interface 204 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. By way of a nonlimiting example, the communication interface 204 may include a host interface (e.g., PCIe or the like) and a network interface (e.g., Ethernet, InfiniBand®, or the like). As described above, the communication interface 204 may include any necessary circuitry components necessary to, for example, enable NVMe, RDMA, and/or any other data transmission protocols.

The DPU 200 may further include a data deduplication engine 208 that may, for example be coupled to a non-transitory storage device (e.g., memory 206). The data deduplication engine 208 may, in some embodiments, comprise the processor 202 or otherwise be communicably coupled with the processor 202. In other embodiments, the DPU 200 may include a separate or distinct processor configured to, alone or in combination with the processor 202, perform the operations described herein. The data deduplication engine 208 may include hardware components designed to access data identifiers indicative of data entries stored by the destination write location 103 and preclude the writing of duplicate data entries to the destination write location 103. The data deduplication engine 208, as described above, may utilize processing circuitry, such as the processor 202, to perform its corresponding operations, and may utilize memory 206 to store collected information.

In some embodiments, the DPU 200 may further include a local data repository 210 that is configured to locally store (e.g., local to the DPU 200) one or more data identifiers indicative of data entries stored by the destination write location 103. In such an embodiment, the local data repository 210 may be non-transitory and may include, for example, one or more volatile and/or non-volatile memories. In other words, for example, the local data repository 210 may also be an electronic storage device (e.g., a computer readable storage medium) comprising gates configured to store data (e.g., bits) that may be retrievable by a machine (e.g., DPU 200 or the like). In such an embodiment, the DPU 200 may be configured to access the local data repository 210, such as to retrieve one or more data identifiers indicative of data entries stored by the destination write location 103. In some embodiments, the memory 206 may comprise the local data repository 210. In other embodiments, the local data repository 210 may be separate from the memory 206.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the DPU 200 may provide or supplement the functionality of particular circuitry.

### Example Methods For Preventing Duplicative Data Writes

FIG. 4 illustrates a flowchart containing a series of operations preventing duplicative data writes (e.g., method 400). The operations illustrated in FIG. 4 may, for example, be performed by, with the assistance of, and/or under the control of a device/apparatus (e.g., DPU 200), as described above. In this regard, performance of the operations may invoke one or more of processor 202, memory 206, communication interface 204, and/or data deduplication engine 208.

As shown in operation 402, the apparatus (e.g., the data deduplication device 102) includes means, such as processor 202, data deduplication engine 208, communication interface 204, and/or the like, for receiving from an initiating device 101, a request for a data write operation. As described above, the initiating device 101 in the data transmission path 100 may be configured to transmit write operations that request/instruct that data be written at a particular destination (e.g., the example destination write location 103). For example, the initiating device 101 may be a host computing device that requests or instructs that data be written to an example backend storage location in the data transmission path 100. As described above, although described herein with reference to an example host device as the initiating device 101 and a backend storage device as the example destination write location 103, the present disclosure contemplates that the data transmission path 100 may include any devices of any type or configuration based on the intended application of the data transmission path 100.

As described above, in some embodiments, the data transmission path 100 may be associated with or otherwise leverage an NVMe based data transmission protocol. In such an example embodiment, the data deduplication engine 208 of the DPU 200 may receive the request for the data write operation at operation 402 in response to an NVMe command (e.g., a “write-ext” command). Although described herein with reference to an NVMe command, the present disclosure contemplates that the receipt of the request for a data write operation by the data deduplication engine 208 of the DPU 200 from the initiating device 101 may occur via any applicable data transmission protocol. The present disclosure contemplates that the command used in this request for the data write operation may be specific to the particular data transmission protocol employed by the data transmission path 100.

The data write operation may be associated with a destination write location 103 as described above and include one or more data identifiers indicative of data entries for writing to the destination write location 103. By way of example, the request for the data write operation received at operation 402 may include or be otherwise associated with a Scatter Gather List (SGL). As would be evident to one of ordinary skill in the art in light, the SGL may refer to the array or other structure that denotes addresses and lengths of a physically continuous scatter/gather region and may be used in data transfers. The SGL of the data write operation may include, denote, define or otherwise be associated with one or more data identifiers indicative of data entries for writing to the destination write location 103. In some embodiments, the one or more data identifiers include Secure Hash Algorithms (SHAs) associated with the data (e.g., data entries, blocks, and/or the like) to be written to the destination write location 103. By way of a nonlimiting example, the data write operation may operate as a key-value (KV) database, hash table, etc. in which the Logical Block Address (e.g., addressing schemes for identifying data of the initiating device 101) is the key and the SHA is the value. For example, if the initiating device 101 transmits a request for a data write operation for writing 32 KB of data and the block size is 4 KB, the SGL will contain 8 SHAs each of which corresponds to a particular block.

Thereafter, as shown in operation 404, the apparatus (e.g., the data deduplication device 102) includes means, such as processor 202, data deduplication engine 208, communication interface 204, and/or the like, for accessing one or more data identifiers (e.g., SHAs or the like) indicative of data entries stored by the destination write location 103. In conventional systems, the access of the data identifiers of data entries already stored by the destination write location 103 (e.g., an example backend storage device) required the DPU or other computing device to access the data stored by the destination write location 103. In doing so, these conventional systems further burdened the network (e.g., providing increased network bandwidth) by having the data identifiers retrieved by the DPU from the destination write location 103. In the embodiments of the present disclosure, however, the DPU 200 may be configured to access the one or more data identifiers indicative of data entries stored by the destination write location 103 without accessing the destination write location 103. Said differently, the data deduplication engine 208 of the present disclosure may be configured to preclude the writing of duplicate data entries to the destination write location 103 in the absence of accessing data stored by the destination write location 103 (e.g., in the absence of a transmission to the destination write location 103).

To access or otherwise obtain the one or more data identifiers indicative of data entries stored by the destination write location, the data deduplication engine 208 of the DPU 200 may access a data repository that is distinct from the destination write location 103. In some embodiments, as shown in operation 406, the data deduplication engine 208 may access the one or more data identifiers indicative of data entries stored by the destination write location 103 by accessing a local data repository 210 of the DPU 200. As shown in FIG. 3, in some embodiments, the DPU 200 may include or otherwise be communicably coupled with the local data repository 210 that is configured to store the one or more data identifiers (SHAs or the like) indicative of data entries stored by the destination write location 103. In other embodiments, as shown in operation 408, the data deduplication engine 208 may access the one or more data identifiers indicative of data entries stored by the destination write location 103 by accessing a remote data repository 114. As shown in FIG. 2, in some embodiments, the DPU 200 may be communicably coupled with the remote data repository 114 that is configured to store the one or more data identifiers (SHAs or the like) indicative of data entries stored by the destination write location 103.

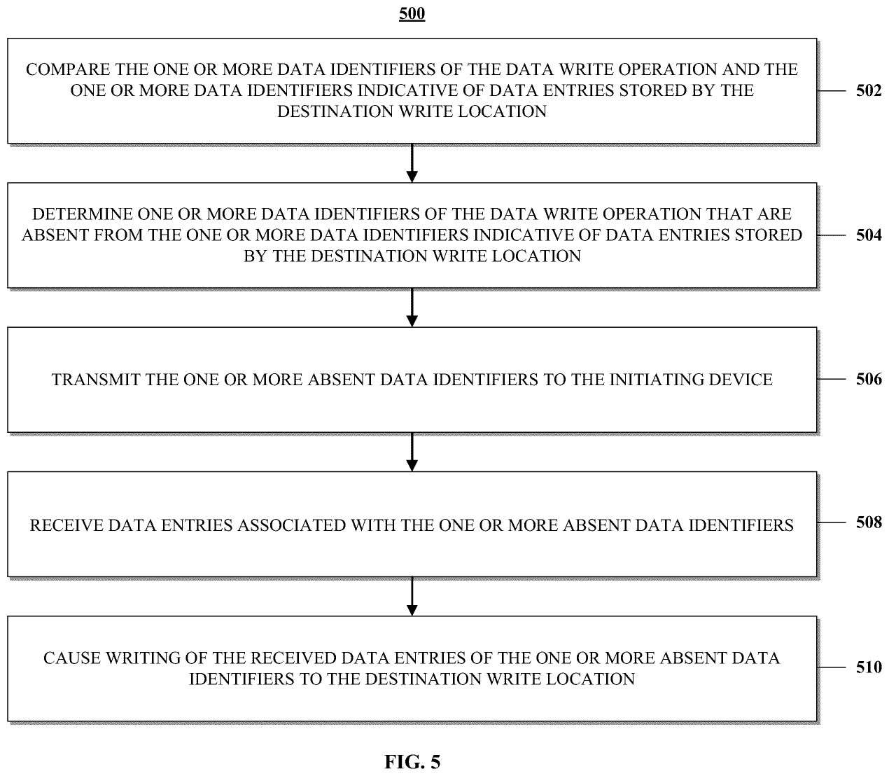

Thereafter, as shown in operation 410, the apparatus (e.g., the data deduplication device 102) includes means, such as processor 202, data deduplication engine 208, communication interface 204, and/or the like, for precluding writing of duplicate data entries to the destination write location 103 based on a comparison between the one or more data identifiers of the data write operation and the one or more data identifiers indicative of data entries stored by the destination write location 103. As described more fully hereinafter with reference to FIG. 5, the data deduplication engine 208 may be configured to retrieve the data identifiers (e.g., SHAs or the like) that are indicative of the data entries currently stored by the destination write location 103 and compare these retrieved data identifiers with the data identifiers of the data write operation received at operation 402. The data deduplication engine 208 may compare these data identifiers to identify data identifiers of the requested data write operation that are missing or otherwise absent from the retrieved data identifiers thereby indicating that the data entries, blocks, etc. associated with these missing data identifiers are not stored by the destination write location 103. For data identifiers of the requested data write operation that are present in the retrieved data identifiers, the data deduplication engine 208 may preclude or otherwise prevent the writing of these data entries to the destination write location 103. In doing so, the data deduplication engine 208 of the DPU 200 may preclude or otherwise prevent the writing of duplicative data entries to the destination write location 103 without accessing the data stored by the destination write location 103.

FIG. 5 illustrates another flowchart containing a series of operations preventing duplicative data writes (e.g., method 500). The operations illustrated in FIG. 5 may, for example, be performed by, with the assistance of, and/or under the control of a device/apparatus (e.g., DPU 200), as described above. In this regard, performance of the operations may invoke one or more of processor 202, memory 206, communication interface 204, and/or data deduplication engine 208.

As shown in operation 502, the apparatus (e.g., the data deduplication device 102) includes means, such as processor 202, data deduplication engine 208, communication interface 204, and/or the like, for comparing the one or more data identifiers of the data write operation requested by the initiating device 101 and the one or more data identifiers indicative of data entries stored by the destination write location 103. As described above, the data deduplication engine 208 may access and/or retrieve one or more data identifiers indicative of data entries stored by the destination write location 103 by accessing either a local data repository 210 and/or a remote data repository 114. The data deduplication engine 208 may compare these data identifiers indicative of data entries stored by the destination write location 103 with the data identifiers associated with the requested data write operation.

Thereafter, as shown in operation 504, the apparatus (e.g., the data deduplication device 102) includes means, such as processor 202, data deduplication engine 208, communication interface 204, and/or the like, for determining one or more data identifiers of the data write operation that are absent from the one or more data identifiers indicative of data entries stored by the destination write location 103. The one or more data identifiers of the data write operation that are absent from the data identifiers indicative of data entries stored by the destination write location 103 may be indicative of unique data entries of the requested data write operation. Similarly, in some embodiments, the data deduplication engine 208 may determine that one or more data identifiers of the data write operation match the one or more data identifiers indicative of data entries stored by the destination write location 103 indicating that the requested data write operation include data entries that are duplicative of the data stored by the destination write location 103.

Thereafter, as shown in operation 506, the apparatus (e.g., the data deduplication device 102) includes means, such as processor 202, data deduplication engine 208, communication interface 204, and/or the like, for transmitting the one or more absent data identifiers to the initiating device 101. As described above, the one or more data identifiers of the data write operation that are absent from the data identifiers indicative of data entries stored by the destination write location 103 may be indicative of unique data entries (e.g., non-duplicative data entries) of the requested data write operation. The data deduplication engine 208 of the DPU 200 may employ any data transmission protocol for transmitting the absent data identifiers to the initiating device 101 without limitation.

Thereafter, as shown in operation 508, the apparatus (e.g., the data deduplication device 102) includes means, such as processor 202, data deduplication engine 208, communication interface 204, and/or the like, for receiving data entries associated with the one or more absent data identifiers. As described above, the one or more absent data identifiers may be indicative of unique data entries of the requested data write operation. As such, the initiating device 101 may receive the absent data identifiers transmitted at operation 506 and transmit only the data entries associated with the absent data identifiers to the DPU 200. By way of a nonlimiting example, the initiating device 101 may transmit the SGLs again after receipt of the absent data identifiers, and the SGLs transmitted may only be indicative of the data identifiers (e.g., SHAs, indices, or the like) that are absent (e.g., only the unique data is sent). At operation 508, the DPU 200 may receive the data entries associated with the absent data identifiers.

Thereafter, as shown in operation 510, the apparatus (e.g., the data deduplication device 102) includes means, such as processor 202, data deduplication engine 208, communication interface 204, and/or the like, for causing writing of the received data entries of the one or more absent data identifiers to the destination write location 103. By way of example, in some embodiments, the DPU 200 may directly cause writing of the data entries associated with the absent data identifiers at the destination write location 103. In other embodiments, the DPU 200 may transmit instructions to the destination write location 103 that include instructions for writing the data entries associated with the absent data identifiers at the destination write location 103. For example, a number of the one or more data identifiers of the data write operation may greater than a number of the absent data identifiers transmitted to the initiating device thereby indicating that the requested data write operation includes data entries that are duplicative of the data stored by the destination write location 103. As would be evident to one of ordinary skill in the art in light of the present disclosure, the DPU 200 may update the data deduplication engine 208 (and/or associated data repositories 114, 210) to include the data identifiers of the unique data written to the destination write location and may complete the command. In doing so, the embodiments of the present disclosure may operate to preclude or otherwise prevent the writing of duplicative data entries to the destination write location 103 without accessing the data stored by the destination write location 103.

Although described herein with reference to example requested data write operations, the present disclosure contemplates that the devices, methods, and systems described herein may also be applicable to data read commands or operations. For example, the data deduplication engine 208 of the DPU 200 may receive a data read command that includes one or more data identifiers indicative of data entries to be read. The data deduplication engine 208 of the DPU 200 may access the one or more data identifiers (e.g., via the repositories 114, 210 or the like) indicative of the data entries stored by the destination write location 103. The data deduplication engine 208 of the DPU may compare the data identifiers and, if the data identifiers of the data read command are present, the DPU 200 may retrieve the associated data from storage.

### Example Methods For Memory System Determination and Duplicative Data Prevention

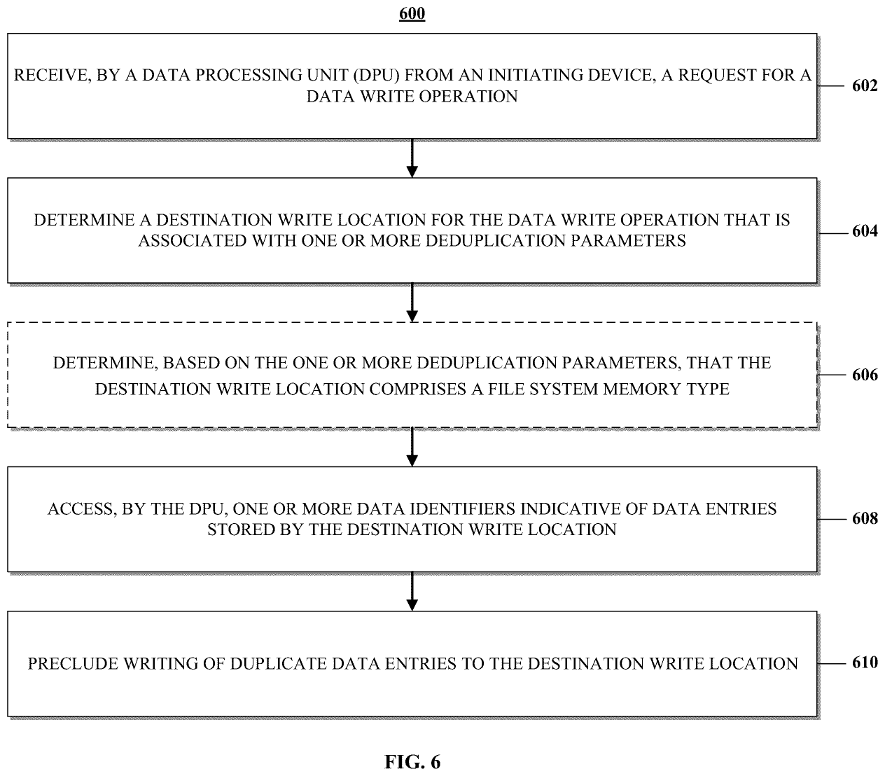

FIG. 6 illustrates a flowchart containing a series of operations for memory system determination and duplicative data write prevention. The operations illustrated in FIG. 6 may, for example, be performed by, with the assistance of, and/or under the control of a device/apparatus (e.g., DPU 200), as described above. In this regard, performance of the operations may invoke one or more of processor 202, memory 206, communication interface 204, and/or data deduplication engine 208.

As shown in operation 602, the apparatus (e.g., the data deduplication device 102) includes means, such as processor 202, data deduplication engine 208, communication interface 204, and/or the like, for receiving from an initiating device 101, a request for a data write operation. As described above with reference to operation 402, the initiating device 101 in the data transmission path 100 may be configured to transmit write operations that request/instruct that data be written at a particular destination (e.g., the example destination write location 103). For example, the initiating device 101 may be a host computing device that requests or instructs that data be written to an example backend storage location in the data transmission path 100. As described above, although described herein with reference to an example host device as the initiating device 101 and a backend storage device as the example destination write location 103, the present disclosure contemplates that the data transmission path 100 may include any devices of any type or configuration based on the intended application of the data transmission path 100.

In some embodiments, the data transmission path 100 may be associated with or otherwise leverage a data transmission protocol that is specific to the memory system type of the destination write location 103. In such an example embodiment, the data deduplication engine 208 of the DPU 200 may receive the request for the data write operation at operation 602 in response to a command specific to the type of memory system of the destination write location 103 (e.g., a “write-ext” command containing virtio descriptors). The present disclosure contemplates that the receipt of the request for a data write operation by the data deduplication engine 208 of the DPU 200 from the initiating device 101 may occur via any applicable data transmission protocol. The present disclosure contemplates that the command used in this request for the data write operation may be specific to the particular data transmission protocol employed by the data transmission path 100, such as specific to the particular memory system type of the destination write location 103.

As shown in operation 604, the apparatus (e.g., the data deduplication device 102) includes means, such as processor 202, data deduplication engine 208, communication interface 204, and/or the like, for determining a destination write location for the data write operation. As described above, the destination write location 103 may be associated with one or more deduplication parameters that are indicative of the type of memory system of the destination write location. By way of example, the one or more deduplication parameters may be associated with or otherwise indicative of a block memory system type, an object memory system type, or a file memory system type. Although described hereinafter with reference to a file system memory configuration as the example type of the destination write location 103, the present disclosure contemplates that the destination write location 103 may include any memory configuration, type, structure, etc. without limitation.

The one or more deduplication parameters of the destination write location 103 may further include data that is indicative of any attribute, configuration, functionality, and/or characteristic of the destination write location 103. By way of example, the one or more deduplication parameters of the destination write location 103 may, in some embodiments, be indicative of a block memory system type. In such an embodiment, the one or more deduplication parameters may indicate to the apparatus (e.g., the data deduplication device 102) the block size associated with the block memory system type. By way of an additional example, the one or more deduplication parameters of the destination write location 103 may, in some embodiments, be indicative of a file memory system type. In such an embodiment, the one or more deduplication parameters may indicate to the apparatus (e.g., the data deduplication device 102) the hierarchal configuration of the example file system.

In some embodiments, the request for the data write operation may include the one or more deduplication parameters associated with the destination write location 103. By way of example, in some embodiments, the data write operation received at operation 602 may include data entries that are indicative of or otherwise associated with the destination write location 103 and may further include one or more deduplication parameters for the destination write location 103. Additionally or alternatively, in some embodiments, the apparatus (e.g., the data deduplication device 102) may determine the one or more deduplication parameters by a system initialization or configuration operation. For example, the data deduplication device 102, upon installation of the device 102, installation of the destination write location 103, or the like, may receive configuration data or other instructions that include the data deduplication parameters of the destination write location(s) 103 associated with the data deduplication device 102.

As described above with reference to FIG. 4, the request for the data write operation received may include or be otherwise associated with a Scatter Gather List that may refer to the array or other structure that denotes addresses and lengths of a physically continuous scatter/gather region and may be used in data transfers. The SGL of the data write operation may include, denote, define or otherwise be associated with one or more data identifiers indicative of data entries for writing to the destination write location 103. In some embodiments, the one or more data identifiers may include virtio descriptors where at least one descriptors include Secure Hash Algorithms (SHAs) associated with the data (e.g., data entries, files, etc.) to be written to the destination write location 103. In some embodiments, as shown in operation 606, the apparatus (e.g., the data deduplication device 102) includes means, such as processor 202, data deduplication engine 208, communication interface 204, and/or the like, for determining, based on the one or more deduplication parameters, that the destination write location comprises a file system memory type. For example, the one or more deduplication parameters, such as received with the data write operation, may indicate to the data deduplication device 102 that the destination write location 103 is a file memory system, and the operations of the data deduplication device 102 may subsequently be specific to a file memory system type.

Thereafter, as shown in operation 608, the apparatus (e.g., the data deduplication device 102) includes means, such as processor 202, data deduplication engine 208, communication interface 204, and/or the like, for accessing one or more data identifiers (e.g., SHAs or the like) indicative of data entries stored by the destination write location 103. As described above with reference to FIG. 4, in conventional systems, the access of the data identifiers of data entries already stored by the destination write location 103 (e.g., an example backend file system) require the DPU or other computing device to access the data stored by the destination write location 103. In the embodiments of the present disclosure, however, the DPU 200 may be configured to access the one or more data identifiers indicative of data entries stored by the destination write location 103 without accessing the destination write location 103. Said differently, the data deduplication engine 208 of the present disclosure may be configured to preclude the writing of duplicate data entries to the destination write location 103 (e.g., an example file memory system) in the absence of accessing data stored by the destination write location 103 (e.g., in the absence of a transmission to the destination write location 103).

To access or otherwise obtain the one or more data identifiers indicative of data entries stored by the destination write location, the data deduplication engine 208 of the DPU 200 may access a data repository that is distinct from the destination write location 103. As described above with reference to operation 406 in FIG. 4, the data deduplication engine 208 may access the one or more data identifiers indicative of data entries stored by the destination write location 103 by accessing a local data repository 210 of the DPU 200. As described above with reference to operation 408 in FIG. 4, in other embodiments, the data deduplication engine 208 may access the one or more data identifiers indicative of data entries stored by the destination write location 103 by accessing a remote data repository 114.

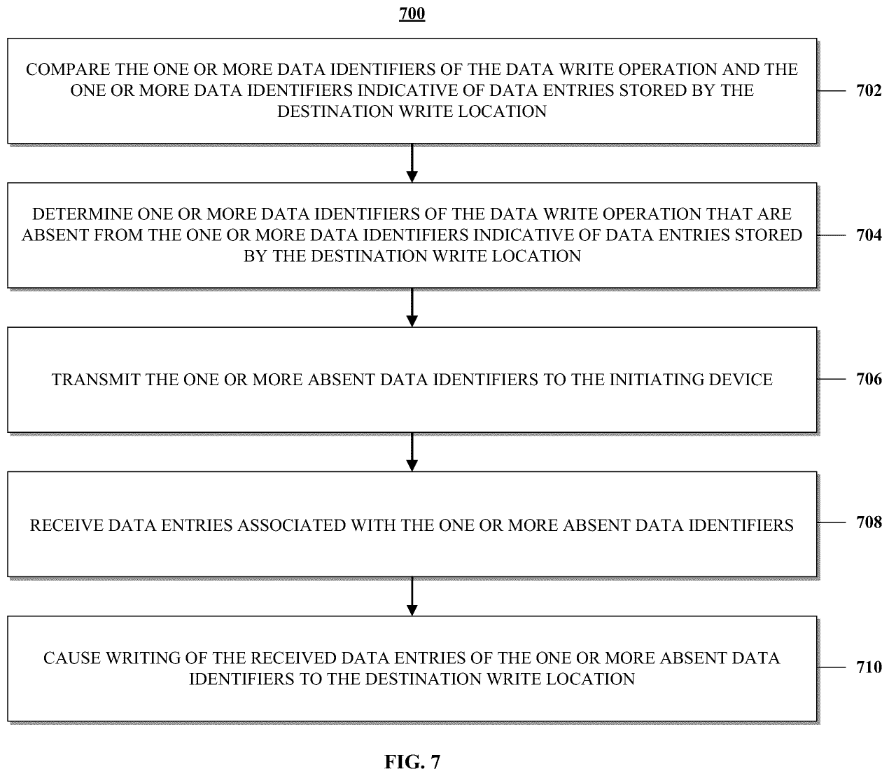

Thereafter, as shown in operation 610, the apparatus (e.g., the data deduplication device 102) includes means, such as processor 202, data deduplication engine 208, communication interface 204, and/or the like, for precluding writing of duplicate data entries to the destination write location 103 based on a comparison between the one or more data identifiers of the data write operation and the one or more data identifiers indicative of data entries stored by the destination write location 103. As described above with reference to FIG. 5 and hereafter with reference to FIG. 7, the data deduplication engine 208 may be configured to retrieve the data identifiers (e.g., SHAs or the like) that are indicative of the data entries currently stored by the destination write location 103 and compare these retrieved data identifiers with the data identifiers of the data write operation received at operation 402. The data deduplication engine 208 may compare these data identifiers to identify data identifiers of the requested data write operation that are missing or otherwise absent from the retrieved data identifiers thereby indicating that the data entries, files, etc. associated with these missing data identifiers are not stored by the destination write location 103. For data identifiers of the requested data write operation that are present in the retrieved data identifiers, the data deduplication engine 208 may preclude or otherwise prevent the writing of these data entries to the destination write location 103. In doing so, the data deduplication engine 208 of the DPU 200 may preclude or otherwise prevent the writing of duplicative data entries to the destination write location 103 without accessing the data stored by the destination write location 103.

In some embodiments, the data deduplication engine 208 may further preclude writing of duplicate data entries to the destination write location 103 based at least in part on the one or more deduplication parameters associated with the destination write location 103. As described above, the one or more deduplication parameters of the destination write location 103 may include data that is indicative of any attribute, configuration, functionality, and/or characteristic of the destination write location 103. By way of continued example, the one or more deduplication parameters of the destination write location 103 may, in some embodiments, be indicative of a file memory system type, and the one or more deduplication parameters may indicate to the apparatus (e.g., the data deduplication device 102) the hierarchal configuration of the example file system. As such, the data deduplication engine 208 may, in the preclusion of write duplicate data entries to the destination write location 103, account for the hierarchal configuration of the example file system. The present disclosure contemplates that the data deduplication engine 208 may account for any memory system specific configurations, functionalities, or the like (e.g., as defined by the one or more deduplication parameters of the destination write location 103) without limitation.

FIG. 7 illustrates another flowchart containing a series of operations preventing duplicative data writes. The operations illustrated in FIG. 7 may, for example, be performed by, with the assistance of, and/or under the control of a device/apparatus (e.g., DPU 200), as described above. In this regard, performance of the operations may invoke one or more of processor 202, memory 206, communication interface 204, and/or data deduplication engine 208.

As shown in operation 702, the apparatus (e.g., the data deduplication device 102) includes means, such as processor 202, data deduplication engine 208, communication interface 204, and/or the like, for comparing the one or more data identifiers of the data write operation requested by the initiating device 101 and the one or more data identifiers indicative of data entries stored by the destination write location 103. As described above, the data deduplication engine 208 may access and/or retrieve one or more data identifiers indicative of data entries stored by the destination write location 103 by accessing either a local data repository 210 and/or a remote data repository 114. The data deduplication engine 208 may compare these data identifiers indicative of data entries stored by the destination write location 103 with the data identifiers associated with the requested data write operation (e.g., a “write-ext” command containing virtio descriptors).

Thereafter, as shown in operation 704, the apparatus (e.g., the data deduplication device 102) includes means, such as processor 202, data deduplication engine 208, communication interface 204, and/or the like, for determining one or more data identifiers of the data write operation that are absent from the one or more data identifiers indicative of data entries stored by the destination write location 103. The one or more data identifiers of the data write operation that are absent from the data identifiers indicative of data entries stored by the destination write location 103 may be indicative of unique data entries of the requested data write operation. Similarly, in some embodiments, the data deduplication engine 208 may determine that one or more data identifiers of the data write operation match the one or more data identifiers indicative of data entries stored by the destination write location 103 indicating that the requested data write operation include data entries that are duplicative of the data stored by the destination write location 103.

Thereafter, as shown in operation 706, the apparatus (e.g., the data deduplication device 102) includes means, such as processor 202, data deduplication engine 208, communication interface 204, and/or the like, for transmitting the one or more absent data identifiers to the initiating device 101. As described above, the one or more data identifiers of the data write operation that are absent from the data identifiers indicative of data entries stored by the destination write location 103 may be indicative of unique data entries (e.g., non-duplicative data entries) of the requested data write operation. In some embodiments, the data deduplication device 102 may leverage RDMA protocols to transmit the one or more absent data identifiers to the initiating device 101.

Thereafter, as shown in operation 708, the apparatus (e.g., the data deduplication device 102) includes means, such as processor 202, data deduplication engine 208, communication interface 204, and/or the like, for receiving data entries associated with the one or more absent data identifiers. As described above, the one or more absent data identifiers may be indicative of unique data entries of the requested data write operation. As such, the initiating device 101 may receive the absent data identifiers transmitted at operation 506 and transmit only the data entries associated with the absent data identifiers to the DPU 200. By way of a nonlimiting example, the initiating device 101 may transmit the SGLs again after receipt of the absent data identifiers, and the SGLs transmitted may only be indicative of the data identifiers (e.g., SHAs, indices, or the like) that are absent (e.g., only the unique data is sent). At operation 708, the DPU 200 may receive the data entries associated with the absent data identifiers. In some embodiments, the data deduplication device 102 may leverage RDMA protocols to directly read the one or more absent data identifiers from a memory of the initiating device 101.

Thereafter, as shown in operation 710, the apparatus (e.g., the data deduplication device 102) includes means, such as processor 202, data deduplication engine 208, communication interface 204, and/or the like, for causing writing of the received data entries of the one or more absent data identifiers to the destination write location 103. By way of example, in some embodiments, the DPU 200 may directly cause writing of the data entries associated with the absent data identifiers at the destination write location 103. In other embodiments, the DPU 200 may transmit instructions to the destination write location 103 that include instructions for writing the data entries associated with the absent data identifiers at the destination write location 103. For example, a number of the one or more data identifiers of the data write operation may greater than a number of the absent data identifiers transmitted to the initiating device thereby indicating that the requested data write operation includes data entries that are duplicative of the data stored by the destination write location 103. As would be evident to one of ordinary skill in the art in light of the present disclosure, the DPU 200 may update the data deduplication engine 208 (and/or associated data repositories 114, 210) to include the data identifiers of the unique data written to the destination write location and may complete the command. In doing so, the embodiments of the present disclosure may operate to preclude or otherwise prevent the writing of duplicative data entries to the destination write location 103 without accessing the data stored by the destination write location 103. As described above, the data deduplication engine 208 may account for any memory system specific configurations, functionalities, or the like (e.g., as defined by the one or more deduplication parameters of the destination write location 103) when precluding the writing of duplicative data entries.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A data processing unit (DPU) comprising:
a non-transitory storage device; and
a data deduplication engine coupled to the non-transitory storage device comprising at least a processor, wherein the data deduplication engine is to:
receive, from an initiating device, a request for a data write operation, wherein the data write operation comprises one or more data identifiers indicative of data entries associated with the data write operation;
determine a destination write location for the data write operation, wherein the destination write location is associated with one or more deduplication parameters;
access one or more data identifiers indicative of data entries stored by the destination write location; and
preclude writing of duplicate data entries to the destination write location based on a comparison between the one or more data identifiers of the data write operation and the one or more data identifiers indicative of data entries stored by the destination write location.

2. The DPU according to claim 1, wherein the one or more deduplication parameters are indicative of a memory system type of the destination write location.

3. The DPU according to claim 2, wherein the data deduplication engine is to determine, based on the one or more deduplication parameters, that the destination write location comprises a file system memory type.

4. The DPU according to claim 1, wherein the request for the data write operation comprises the one or more deduplication parameters associated with the destination write location.

5. The DPU according to claim 1, wherein the data deduplication engine is to further preclude writing of duplicate data entries to the destination write location based at least in part on the one or more deduplication parameters associated with the destination write location.

6. The DPU according to claim 1, wherein the one or more data identifiers indicative of data entries stored by the destination write location are stored locally by the DPU.

7. The DPU according to claim 1, wherein, in accessing the one or more data identifiers indicative of data entries stored by the destination write location, the data deduplication engine is to access a data repository storing the one or more data identifiers indicative of data entries stored by the destination write location.

8. The DPU according to claim 7, wherein the data repository is distinct from the destination write location.

9. The DPU according to claim 1, wherein the data deduplication engine is configured to access the one or more data identifiers indicative of data entries stored by the destination write location in the absence of a transmission to the destination write location.

10. The DPU according to claim 1, wherein the data deduplication engine is further to:
compare the one or more data identifiers of the data write operation and the one or more data identifiers indicative of data entries stored by the destination write location; and
determine one or more data identifiers of the data write operation that are absent from the one or more data identifiers indicative of data entries stored by the destination write location.

11. The DPU according to claim 10, wherein the data deduplication engine is further to:
transmit the one or more absent data identifiers to the initiating device;
receive data entries associated with the one or more absent data identifiers; and
cause writing of the received data entries of the one or more absent data identifiers to the destination write location.

12. The DPU according to claim 11, wherein a number of the one or more data identifiers of the data write operation is greater than a number of the absent data identifiers transmitted to the initiating device.

13. The DPU according to claim 11, wherein the data deduplication engine is to receive the data entries associated with the one or more absent data identifiers via Remote Direct Memory Access (RDMA).

14. The DPU according to claim 1, wherein the one or more data identifiers comprise Secure Hash Algorithms (SHAs).

15. The DPU according to claim 1, wherein the data deduplication engine is to preclude writing of duplicate data entries to the destination write location in the absence of accessing data stored by the destination write location.

16. A computer-implemented method comprising:
receiving, by a data processing unit (DPU) from an initiating device, a request for a data write operation, wherein the data write operation comprises one or more data identifiers indicative of data entries associated with the data write operation;
determining, by the DPU, a destination write location for the data write operation, wherein the destination write location is associated with one or more deduplication parameters;
accessing, by the DPU, one or more data identifiers indicative of data entries stored by the destination write location; and
precluding, by the DPU, writing of duplicate data entries to the destination write location based on a comparison between the one or more data identifiers of the data write operation and the one or more data identifiers indicative of data entries stored by the destination write location.

17. The method according to claim 16, wherein the one or more deduplication parameters are indicative of a memory system type of the destination write location.

18. The method according to claim 17, further comprising determining, based on the one or more deduplication parameters, that the destination write location comprises a file system memory type.

19. The method according to claim 16, wherein the request for the data write operation comprises the one or more deduplication parameters associated with the destination write location.

20. The method according to claim 16, wherein precluding the writing of duplicate data entries to the destination write location is further based at least in part on the one or more deduplication parameters associated with the destination write location.
